(19) United States
(12) Patent Application Publication
(10) Pub. No.: US 2010/0242250 A1
(43) Pub. Date: Sep. 30, 2010

(54) MAGNETIC BLOCKS AND METHOD OF MAKING MAGNETIC BLOCKS

(75) Inventors: Christopher Harwood Haughey, Los Angeles, CA (US); William Harcourt Haughey, Rowayton, CT (US); William Joseph Delisle, Mountain View, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Tegu, Los Angeles, CA (US)

(21) Appl. No.: 12/412,049

(22) Filed: Mar. 26, 2009

(51) Int. Cl. B23P 17/04

(52) U.S. Cl. 29/428

(57) ABSTRACT

A method of making blocks with internally disposed magnets. Pockets for the magnets are machined into a non-extrudable material such as wood. Strong permanent magnets are disposed in the pockets to cause the faces of the block to exhibit a desired polarity magnetic field. The pockets are then sealed to permanently retain the magnets. The exterior shape of the block may be formed either prior to or subsequent to machining and sealing of the pockets.

### BACKGROUND

1. Field of the Invention

Embodiments of the invention relate to wooden blocks. More specifically, embodiments of the invention relate to wooden blocks having internally disposed permanent magnets.

2. Background

Blocks are one of the quintessential toys that have been around for generations. Over the years, blocks have been made of wood, various plastics, and assorted other materials. Traditional blocks are merely geometric shapes that can be stacked or arranged to build things without any real interconnection between the blocks. These traditional blocks rely on influence of gravity to maintain a position within the structure. Many structures are impossible to build with such blocks. Other block-like toys, such as LEGO® have a mechanical interconnection which allows user to build more complex structures. To address some of the limitations of blocks, efforts have been made to introduce magnets into blocks so that magnetic coupling is possible between adjacent blocks in a structure. Introduction of these magnets is relatively simple and cost effective where underlying material used is extrudable, such as in the context of plastic blocks. However, in this case of non-extrudable materials, such as wood, the techniques used with extrudable materials do not apply.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1 is an exploded view of a block made in accordance with one embodiment of the invention.

FIG. 2 is a schematic diagram of multiple block halves created in a pair of substrates according to one embodiment of the present invention.

FIGS. 3A-3C are views of one half of an alternative block that may be produced in accordance with one embodiment of the invention.

FIG. 4 is a flow diagram of a process of making blocks in accordance with one embodiment of the invention.

FIG. 5 is a diagram of a block produced in accordance with one embodiment of the invention.

FIG. 6 is a diagram of a block formed in accordance with another embodiment of the invention.

### DETAILED DESCRIPTION

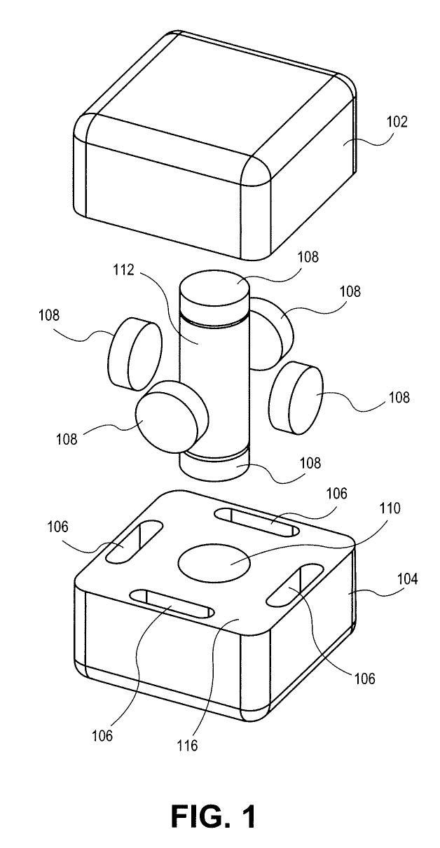

FIG. 1 is an exploded view of a block made in accordance with one embodiment of the invention. In FIG. 1, the ultimate geometric shape is a cube with rounded edges, which is formed as a first half 102 and a second half 104. The first half 102 and second half 104 may be formed individually or in groups from a substrate as described below. Hard wood is a preferred material for manufacture. Wood has a warmth and tactile response that is not attainable in extrudable synthetics. But its non-extrudable nature renders it more challenging from a manufacturing standpoint.

Pockets 106 are defined in both the top half 102 and the bottom half 104 to receive magnets 108 and hold them internally adjacent to the side faces of the cube. A central bore 110 in each of the top and bottom halves 102, 104 defines a pocket to receive magnets 108 internally proximate to the top and bottom faces of the cube. A spacer such as dowel 112 retains top and bottom magnets 108 proximate to the respective external surface. While the spacer is shown as a cylinder other shapes of spacers may be used.

By appropriately orienting magnets 108 inserted into pockets 106 and bore 110, the polarity exhibited by each face of the cube can be controlled. It is generally believed to be desirable to have an equal number of north pole faces and south pole faces on a particular block. But, some embodiment of the invention may have different polar organization such as four north and two south, or vice versa. There may even be cases where a particular block is monopolar, i.e., all faces exhibit either a north pole or a south pole.

Top half 102 and bottom half 104 may be coupled together along interface surface 116. In one embodiment, an adhesive such as wood glue may be used to achieve the coupling. Because of the relatively large surface area of interface surface 116, strong adhesion occurs and disassembly of the blocks is less likely. Particularly in the context of toys for children, disassembly is highly undesirable as the magnets and other small parts may then represent a choking hazard. It is preferred to use wood glue that is approved for indirect food contact such as Titebond II and Titebond III commercially available. By appropriately grain matching the source of the top half 102 and bottom half 104, the line of adhesion can be rendered nearly imperceptible.

Magnets 108 may be rare earth magnets that generate a magnetic field in the range of 10,000 to 13,500 gauss. For example, magnets 108 may be Neodymium Iron Boron (NdFeB) magnets, which have an exceedingly strong attraction to one another and to other ferromagnetic objects, subject to factors such as the size and shape of the magnets and their relative orientation and proximity to one another and/or other ferromagnetic objects. N40 grade cylindrical magnets ⅛ inch thick and ⅜ inch in diameter have been found suitable for blocks having a 30 mm side. Larger size blocks may make a stronger magnet desirable. Stronger attraction may be achieved with larger or higher grade magnets. The strong magnetic connections between the blocks allow for the construction of structures which are impossible to sustain with normal, non-magnetic blocks. Additionally, the strong forces generated between the blocks (both attraction and repulsion, depending on relative orientation) are surprising and delighting to children and adults, given the hidden nature of the magnets within the blocks (fully encased). Depending on the base material used in the block structure itself, the look, feel and sound of the blocks “clicking” or “clacking” when they come together rapidly as a result of the magnetic attraction is attractive and makes for an enjoyable play experience. When two blocks are placed near one another on a surface or in space, the blocks will sometimes move or spin, seemingly of their own accord, as the magnets 108 within them attract and/or repel one another, creating an apparently “magical” phenomenon.

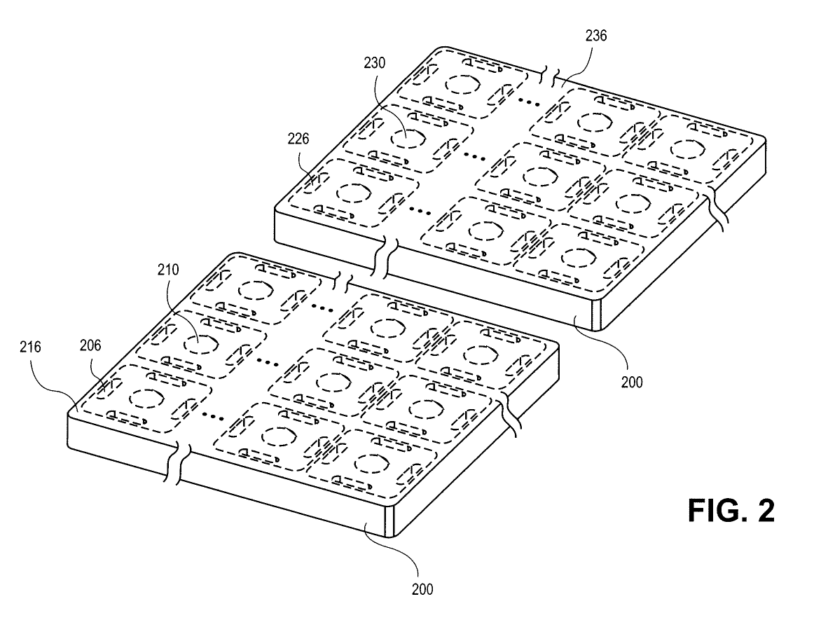

FIG. 2 is a schematic diagram of multiple block halves created in a pair of substrates according to one embodiment of the present invention. The ultimate desired shape may be defined within a computer. The machining of a substrate such as boards 200 and board 220 is computer-driven. The machining forms pockets 206 and central bore 210 for a plurality of halves 202. Boards 200 and 220 may permit an arbitrarily large array of halves to be machined therein. In some embodiments, depending on the size of the boards 200, 220 and the size of the ultimate desired shape, the array may be two dimensional or one dimensional.

For economic reasons it is desirable to minimize the space between the halves along the board and therefore the sacrificial or waste product when the ultimate geometric shape is separated from the rest. By selecting two boards 200 and 220 having closely matching grain (also referred to as grain matching), the interface between halves can be hidden. Since the grain of both substrates matches a second set of halves can be machined to have corresponding pocket 226 and bore 230 in board 220 which will couple to the first set shown in FIG. 2 by gluing the boards 200, 220 together. The magnets inserted into pockets 206 and a spacer inserted into bore 210 help to align the respective boards 200,220 which can be glued together along their length so that a solid adhesion exist between contact areas 216 and 236. The individual desired shapes may then be separated with either standard or computer-driven tooling. While the description above refers to “halves” it is not strictly necessary that the two pieces that form the final block be identical or symmetric. But symmetry does simplify tooling.

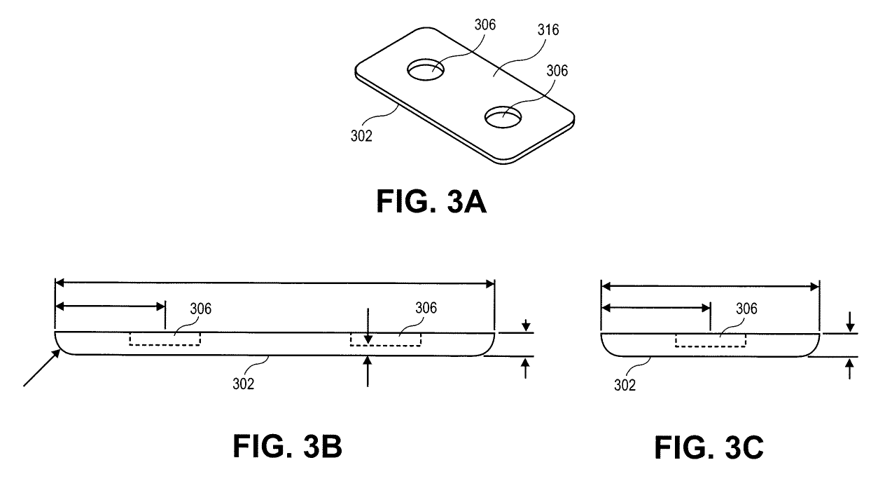

FIGS. 3A-3C are views of one half of an alternative block that may be produced in accordance with one embodiment of the invention. FIG. 3A is an isometric view showing half 302 which has defined therein two pockets 306 and an interface surface 316. Plural halves can be defined and machined into a single substrate as described with reference to FIG. 2. FIG. 3B shows a side view of half 302 with pockets 306 shown in phantom lines. Pockets 306 are defined to accept a suitable magnet. While pockets 306 are shown as circular and therefore accepting a cylindrical magnet, rectangular pockets or any other shaped pocket could also be defined. It is desirable that the magnet fits snugly within the pocket so as not to rattle around during use. Block 302 is defined to be twice the length of a cube face such as the cubes of FIG. 1 and may be used as a spacer in construction projects. Half 302, in one embodiment, has a thickness of 3 mm and a 3 mm radius curvature at the edges. FIG. 3C shows an end view of block half 302. While half 302 is shown to be 60 mm long other shapes and dimensions of blocks made in an analogous manner are envisioned. For example, block half 302 could be any integer number of cube faces in length, for example, 90 mm, 120 mm, etc. where the cube face is 30 mm across. It is also envisioned that the number of magnet pockets defined may or may not increase with length. For example, a 90 mm plank may have three magnets or only two.

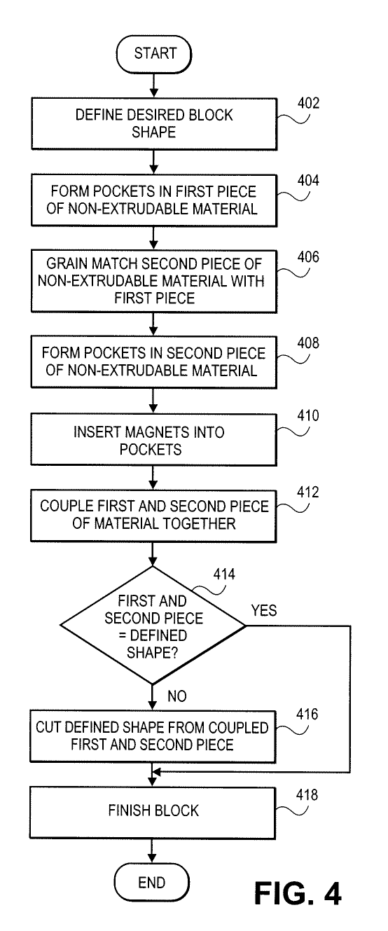

FIG. 4 is a flow diagram of a process of making blocks in accordance with one embodiment of the invention. At box 402, the desired block shape is defined. Definition may take the form of a computer file which then may be used to drive the subsequent machining of the block from a substrate. In other embodiments, the ultimately desired geometric shape may be formed at the definition stage and the processed individually as described below.

At box 404, pockets are formed in a first piece of non-extrudable material. These pockets may correspond to, for example, pockets 306 as shown in FIG. 3A or pockets 106 and bore 110 as shown in FIG. 1. By forming the pockets sized to snugly hold the magnets rattling of the finished block may be avoided. Alternatively the magnets may be adhered within the pockets. At box 406, the second piece of non-extrudable material is grain-matched with the first piece. With grain-matching, once the first and second pieces of material are coupled together to form the ultimate desired shape, a visual distinction between the pieces may be rendered substantially imperceptible (the block visually appears to be formed from one solid piece of material). At box 408, pockets are formed in a second piece of non-extrudable material. Such pockets correspond to the pockets formed in the first piece at box 404 such that the two pieces in conjunction form all or a greater part of the desired geometric shape.

At box 410, magnets are inserted into respective pockets such that a desired polarity is exhibited by the corresponding adjacent face. As noted above, in some embodiments, the magnets may be adhered to the pocket to prevent movement of the magnet within the pocket. In some embodiments, it is desired to ensure that there are an equal number of faces of each polarity. At box 412, the first and second pieces of non-extrudable material are coupled together sealing the pockets and permanently encapsulating the magnets. In one embodiment, this coupling is the result of adhesion with the use of, for example, wood glue.

Box 414 is an implicit decision whether the desired block has been made individually such as where the desired block shape is rendered at definition box 402 or if the block is defined as part of, for example, a pair of larger substrates (as discussed with reference to FIG. 2). If the block is not yet rendered, the defined shape is cut from the first and second pieces of material after they are coupled together, at block 416. Once the desired block shape is obtained, the block may be finished at 418. In some embodiments, finishing may include any of sanding, staining and varnishing or otherwise coating the block.

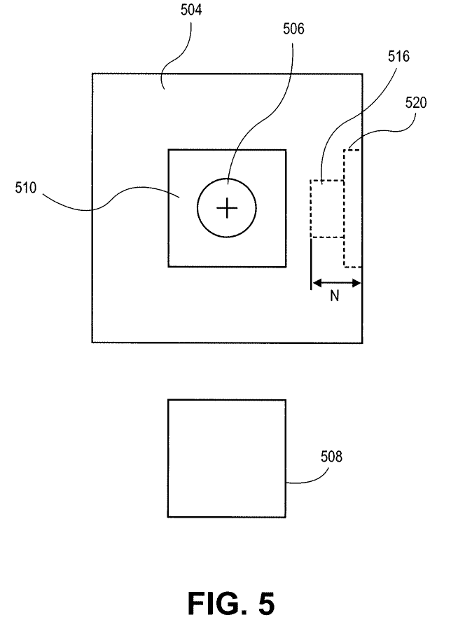

FIG. 5 is a diagram of a block produced in accordance with one embodiment of the invention. A pocket is formed in each face by boring to a depth N at approximately the face center. Additional material is machined from area 510 to a depth of N minus the magnet thickness. Plug 508 is then used to overlay the magnet 506 deposited within the pocket. Because the adhesion surface 510 is relatively large, the risk of disassembly is reduced, in contrast to a case where only the edges of a plug having the same dimensions as the magnet were used. Such edge-only adhesion has been found to be unsuitable for strong permanent magnets as used here. While plug 508 is shown as rectangular, area 510 can be formed in any shape and therefore plug 508 could be formed in any shape. What is important is that the adhesive surface area over match the magnetic force so that the plug does not dislodge during normal use.

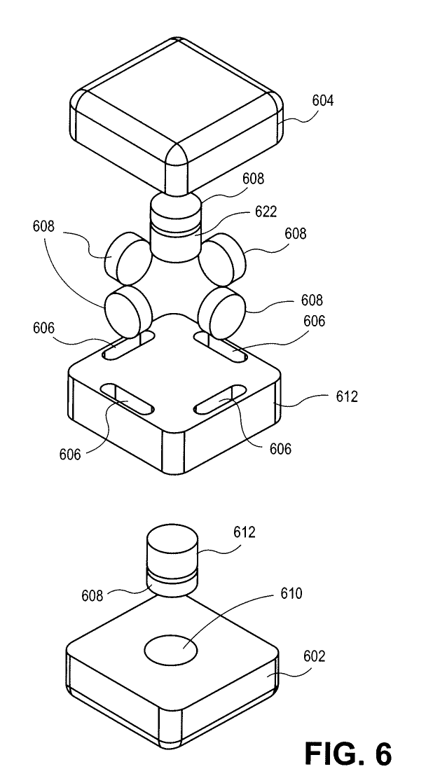

FIG. 6 is a diagram of a block formed in accordance with another embodiment of the invention. In this example, the cube is formed of three pieces, top piece 604, bottom piece 602 and a middle layer 612. The pockets for the top and bottom are formed as a bore 610 in bottom piece 602 and top piece 604, respectively. Pockets 606 for the side face magnets are formed in middle layer 612. The top 604 and bottom 602 portions then sandwich the middle layer 612. A spacer 622 and 632 retain the bottom and top magnets 608 proximate to their respective faces. It should be understood that this embodiment can be produced in the same manner as described with reference to FIG. 4 and FIG. 2.

In the foregoing specification, the embodiments of the invention have been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
forming a pocket to be adjacent to a center of each face of a plurality of faces of a defined geometric solid of a non-extrudable material;
inserting a permanent magnet into each pocket such that a number of faces exhibiting a north polarity is equal to a number of faces exhibiting a south polarity; and
sealing the pockets to permanently retain the permanent magnets.

2. The method of claim 1 wherein forming comprises:
boring a hole in the center of each face having a diameter consistent with a diameter of the magnet to be inserted and a depth n where n is greater than a thickness of the magnet; and
removing an area of material around to a depth of approximately n minus magnet thickness.

3. The method of claim 2 wherein sealing comprises:
adhesively coupling a plug to the face coextensive with the area of material removed.

4. The method of claim 1 wherein forming comprises:
machining the pockets into an interior of a plurality of sub-pieces to be assembled into the geometric solid such that the pockets are internally adjacent to each face of the defined geometric solid and externally invisible.

5. The method of claim 4 wherein sealing comprises:
adhering the sub-pieces together to complete the geometric solid.

6. A method comprising:
defining a desired ultimate geometric shape;
forming at least one pocket portion in a first piece of non-extrudable material the pocket to be internally proximate to an external face of the ultimate geometric shape;
forming at least one pocket portion in a second piece of non-extrudable material to be internally proximate to an external face of the ultimate geometric shape;
disposing a permanent magnet in each pocket; and
coupling the first piece of material to the second piece of material.

7. The method of claim 6 further comprising:
cutting the ultimate geometric shape from the first and second piece after coupling.

8. The method of claim 6 wherein coupling comprises:
adhering the first piece of material to the second piece of material.

9. The method of claim 6 further comprising:
grain matching the first piece of material and the second piece of material.

10. The method of claim 6 further comprising:
finishing the ultimate geometric shape.

11. The method of claim 10 further comprising:
sanding and coating the ultimate geometric shape.

12. The method of claim 6 wherein disposing comprises:
inserting the permanent magnets into the pockets in a polarity orientation such that an aggregate number of north poles internally proximate to the external faces is equal to an aggregate number of south poles internally proximate to the external faces after the adhering.

13. The method of claim 6 wherein the desired alternate geometric shape is a cube and wherein forming further comprises:
machining corresponding slots adjacent to each side face of the alternate geometric shape defined in both the first piece and the second piece;
machining a central bore in each of the first piece and the second piece, the central bore terminating internally proximate to a top face and a bottom face respectively.

14. The method of claim 13 further comprising:
inserting a spacer into the central bore to retain magnets at respective terminal ends of the bore.

15. The method of claim 6 wherein the permanent magnets comprise:
cylindrical NdFeB magnets.

16. The method of claim 6 wherein coupling comprises:
applying an adhesive to substantially an entire area of a contact surface between the first piece and the second piece.
